(19) United States
(12) Patent Application Publication
(10) Pub. No.: US 2012/0145977 A1
(43) Pub. Date: Jun. 14, 2012

(54) Chair Lifting and Moving Assembly

(76) Inventor: Kenneth A Hufstater, Windermere, FL (US)

(21) Appl. No.: 12/968,252

(22) Filed: Dec. 14, 2010

(51) Int. Cl. B62B 3/06; B66F 5/00; B66F 5/04; B62B 3/065

(52) U.S. Cl. 254/2 R

(57) ABSTRACT

A chair lifting and moving assembly provides stable, efficient, and safe loading and unloading of multiple stacks of stacked chairs. The assembly has at least two chair members to lift the stacks of chairs, a lifting member to at least lift the front portion of the chair members, and the handle to move the chair lifting and moving assembly. The assembly has wheel supports disposed along a longitudinal axis of each of the chair members to provide further stability.

### FIELD OF THE INVENTION

In convention centers, hotels, and other venues for hosting large numbers of people, stackable chairs are used for seating the large numbers of people. It is important to be able to quickly and safely move the stackable chairs around the venues. Stacks of the stackable chairs are typically moved using a chair dolly. A typical chair dolly is a modified hand truck that is rolled under a single stack of chairs, which is then leaned backwards to lift the legs of the bottommost chair off the ground. The operator must typically hold the chair dolly with one hand and the stack of chairs in the other hand to safely move the chairs around the venue. This arrangement requires both strength and balance on the part of the operator. Additionally, only one stack of chairs, typically limited to 10-12 chairs, may be moved at a time.

This system is therefore limited in the number of chairs that can be moved in a given trip in the safety of the movement of the chairs is dependent upon the balance and strength of the operator. Therefore, a chair lifting and moving assembly that is capable of moving a larger number of chairs that is not dependent upon the operator strength or balance is needed.

### SUMMARY OF THE INVENTION

The present invention is directed to an assembly for moving multiple stacks of stackable chairs in a safe, efficient, and expeditious manner.

According to one aspect of the present invention, a chair lifting and moving assembly includes a frame having a plurality of wheels, at least two chair members, each of the at least two chair lifting members having a front portion and a rear portion, a lifting member operatively coupled to the at least two chair members and the frame to lift at least the front portion of the two chair members, and a handle attached to the at least two chair members.

In some embodiments, the at least two chair members are adjustably attached to the frame.

In some embodiments, the frame has two wheel supports, each of the wheel supports disposed along a longitudinal axis of a respective one of the at least two chair members.

In other embodiments, at least one wheel on the wheel supports is disposed under each of the at least two chair members.

In yet another aspect, a chair lifting and moving assembly includes a frame having a plurality of wheels, at least two chair members, each of the at least two chair lifting members having a front portion and a rear portion, and a lifting member operatively coupled to the at least two chair members and the frame to lift at least the front portion of the two chair members.

In yet another aspect, a chair lifting and moving assembly includes a frame, the frame having two wheel supports and the two wheel supports having a plurality of wheels, at least two chair members, each of the at least two chair lifting members having a front portion and a rear portion, and a lifting member operatively coupled to the at least two chair members and the frame to lift at least the front portion of the two chair members. at least one wheel on the wheel supports is disposed under each of the at least two chair members, wherein each of the wheel supports is disposed along a longitudinal axis of a respective one of the at least two chair members.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is top perspective view of one embodiment of a chair lifting and moving assembly according to the present invention;

FIG. 2 is a rearview of the chair lifting and moving assembly of FIG. 1;

FIG. 3 is a side view of the chair lifting and moving assembly of FIG. 1;

FIG. 4 is a top view of the chair lifting and moving assembly of FIG. 1;

FIG. 5 is a side view of the chair lifting and moving assembly of FIG. 1 approaching a stack of chairs;

FIG. 6 is a side view of the chair lifting and moving assembly of FIG. 5 with the stack of chairs in a lifted position; and

FIG. 7 is a top perspective view of another embodiment of a chair lifting and moving assembly according to the present invention.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

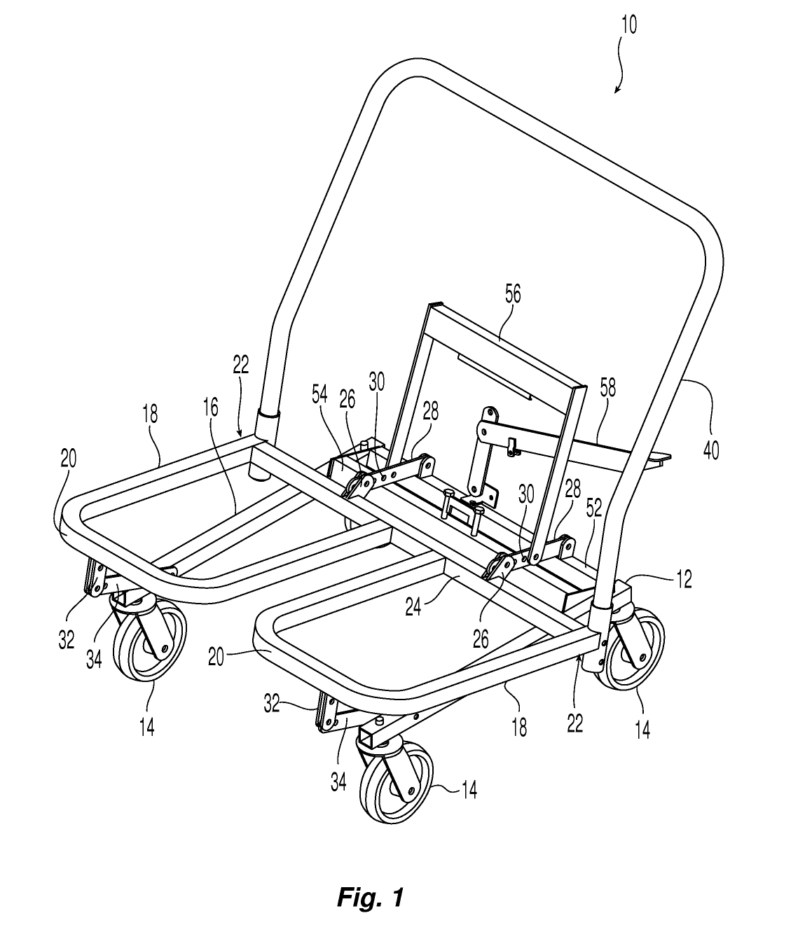

Referring to FIGS. 1-4, a chair lifting and moving assembly 10 is illustrated. The chair lifting and moving assembly 10 has a frame 12, the frame 12 having a plurality of wheels 14 attached to a respective one of the wheel supports 16. The chair lifting and moving assembly 10 also has at least two chair members 18 for engaging and lifting stacks of chairs. The chair members 18 have a front portion 20 and a rear portion 22. The rear portion 22 of the chair members 18 are attached to a chair support member 24, which extends across the back of the chair members 18 and parallel to the frame 12. The chair support member 24 is also attached to tabs 26, which are adjustably attached to the links 28, which in turn are rotatably attached to the frame 12. The links 28 have a plurality of openings 30 therein to allow for a variety of positions of the rear portion 22 of the chair members 18 relative to the back of the bottom chair in the stack of chairs to be lifted. The front portion 20 also has tabs 32 to rotatably attach to links 34, which are fixedly attached to the wheel supports 16.

A handle 40 is attached to the rear portion 22 of the chair lifting members 18, although the handle 40 could be attached to the chair support member 24 or even the frame 12.

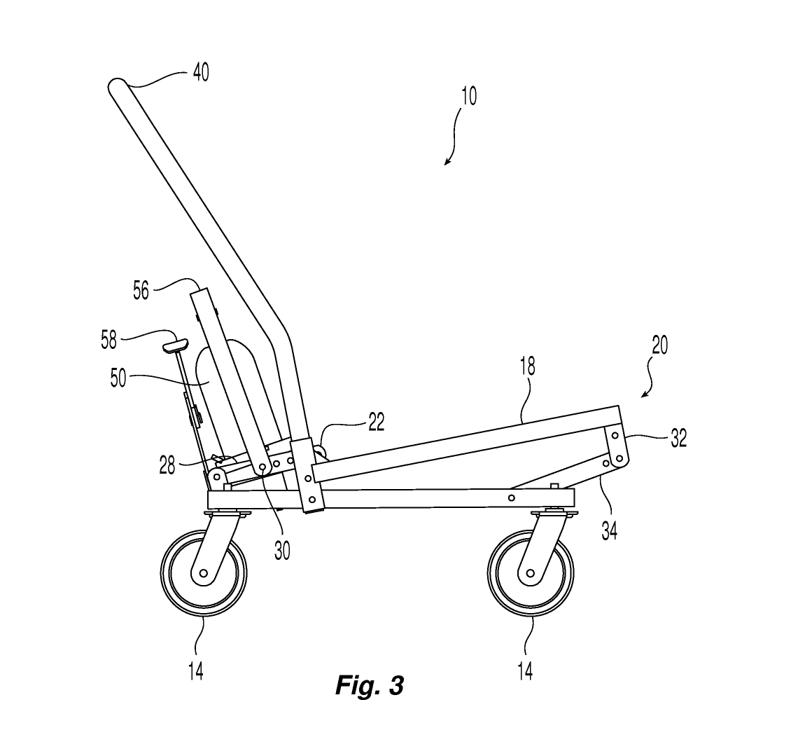

A lifting member 50, which is preferably a hydraulic pump, is secured to the frame 12, and more particularly to the two cross members 52, 54. The lifting member 50 is also connected to the U-shaped element 56, which is connected to the links 28. When the lifting member 50 is activated, typically by the foot pedal 58, it pushes upward on the U-shaped element 56, which in turn pulls the links 28 upward. The links 28 in turn pull upward on the chair members 18 thereby lifting the chair members 18. The lifting member 50 is illustrated in FIG. 3 but not in the other figures so as to block the view of the other components of the assembly 10. While a bottle-type hydraulic pump is illustrated, other lifting mechanisms are also possible and fall within the scope of the present invention, including for example, hand or powered lead screws and nuts (Acme screws), cable winch, chain drive or a ratcheting jack.

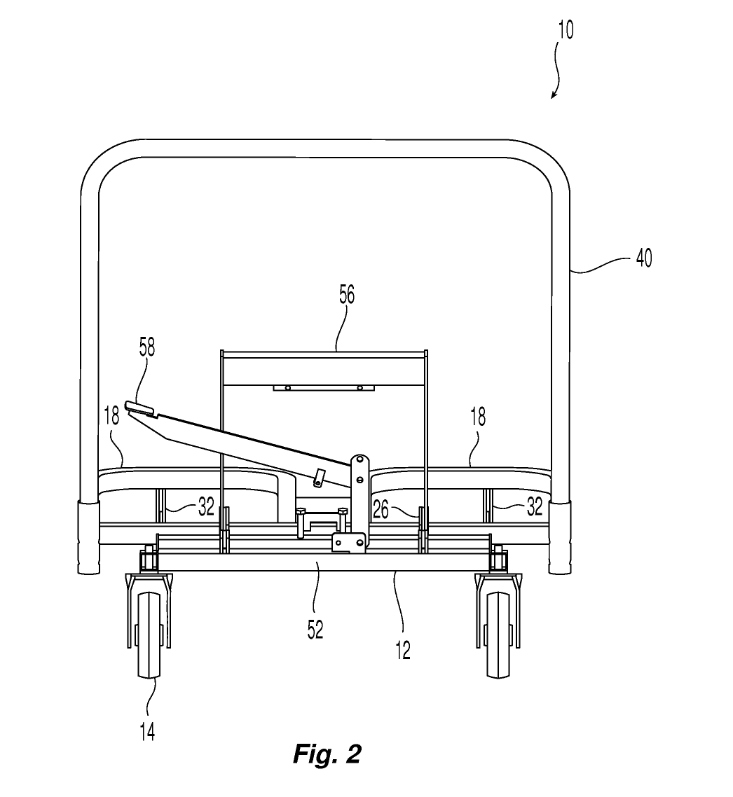

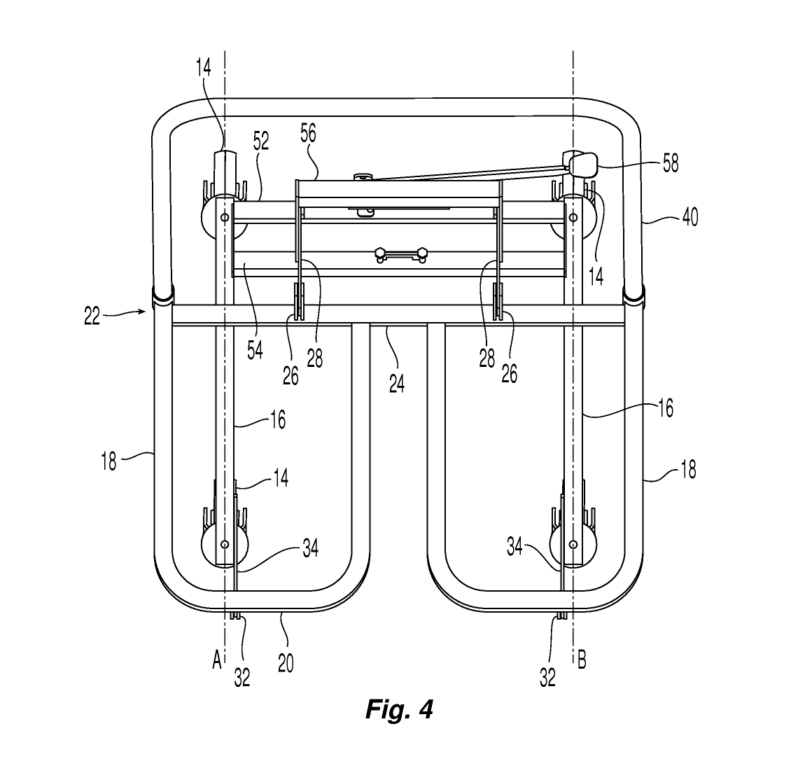

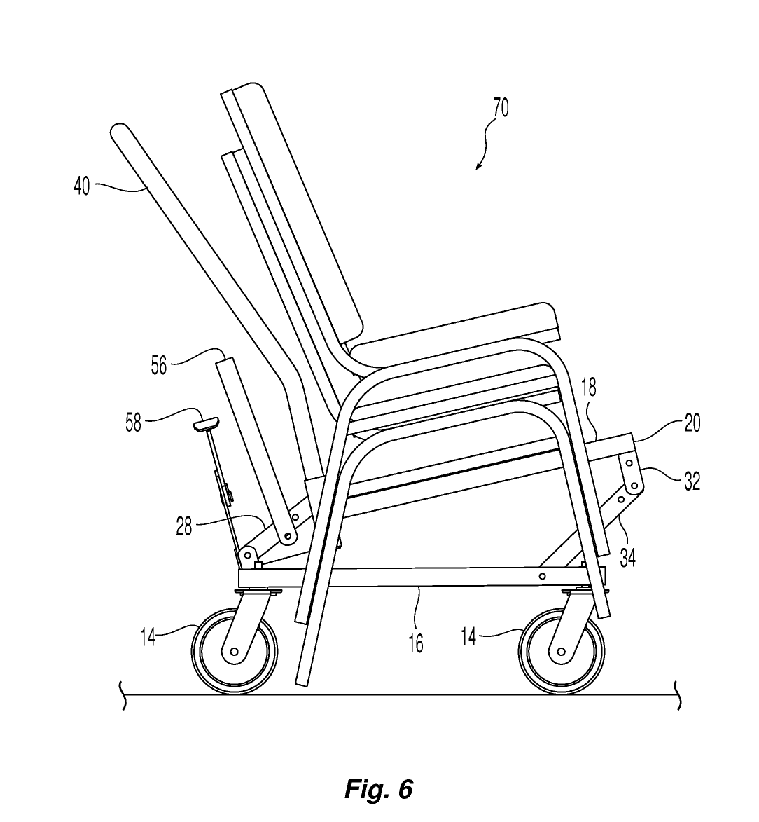

As can be better seen in FIGS. 2 and 4, the two chair members 18 are separated by a distance sufficient to allow the legs from two stacks of stacked chairs to fit therebetween. Additionally, the wheel supports 16 are positioned along a longitudinal axis (A,B) extending through the front portion 20 in the rear portion 22 of the chair members 18. This provides increased ability for the chair lifting and moving assembly 10 when loaded with two stacks of stacked chairs as illustrated in FIG. 6. All of the wheels 14 are illustrated as being able to swivel. However, it is within the scope of the invention that some of the wheels 14 do not swivel and/or could be locked so as to prevent them from swiveling.

As noted above, the links 28, 34 and the tabs 32 each have multiple openings therein to control the amount of lift for each of the chair members 18. It is possible, by adjusting the connection point of the links 28, 34 with the tabs, for the rear portion 22 of the chair members 18 to be lifted higher than the front portion 20. The adjustability of the chair members 18 may be dependent upon the configuration of the chairs to be lifted. However, the front portion 20 of the chair members 18 is always lifted in operation.

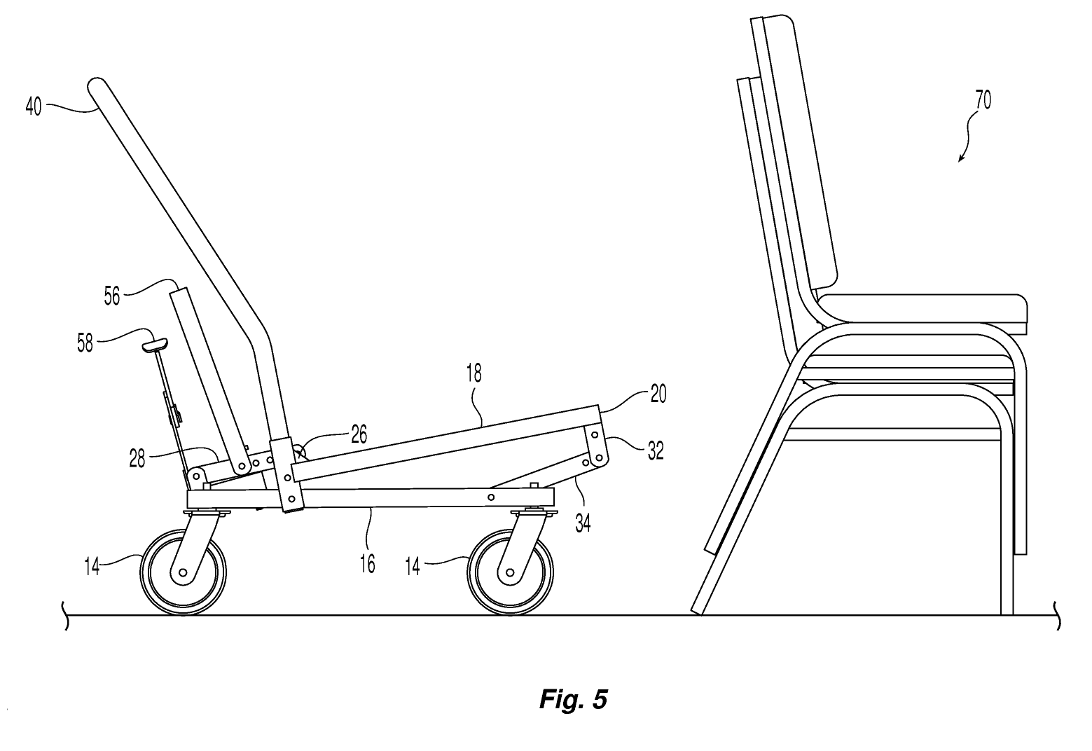

FIGS. 5 and 6 illustrate the chair lifting and moving assembly 10 approaching stacks of chairs 70. While only two chairs are illustrated, more chairs can be included in the stack 70, generally between 10 and 12 are typical. After operation of the lifting member 50, the stack of chairs 70 is fully supported by the assembly 10 without any assistance from an operator. It should be noted, that the handle 40 may be used to assist in supporting the stack of chairs.

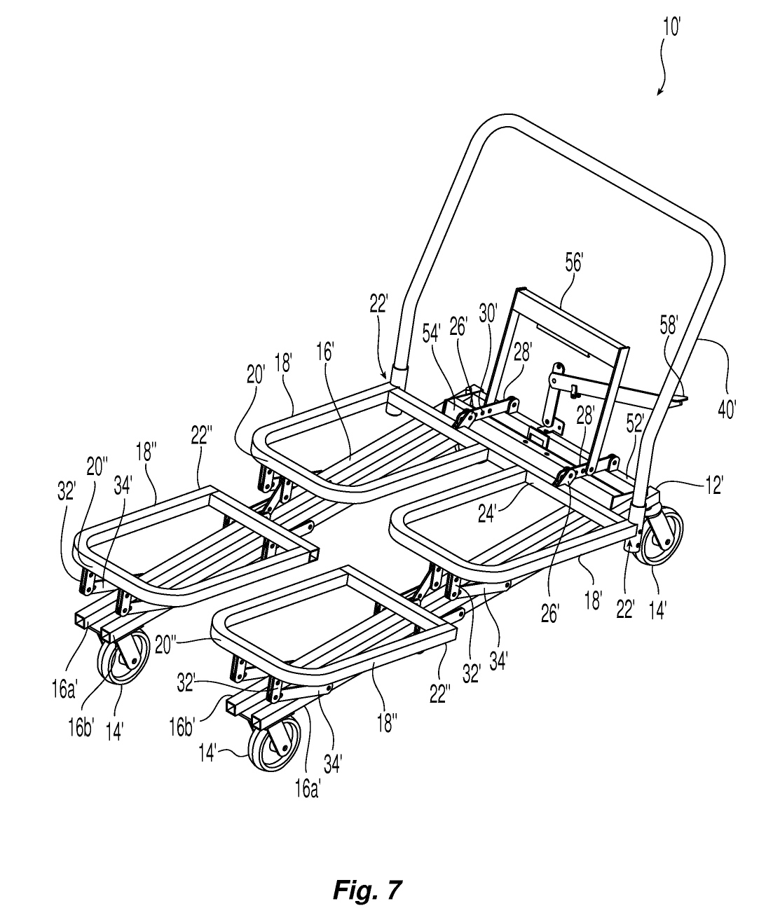

An alternative embodiment of the chair lifting and moving assembly 10′ according to the present invention is illustrated in FIG. 7. The operation and elements of assembly 10′ is the same as noted above. However, assembly 10′ has four chair members, the rear chair members 18′ and the front chair members 18″ to support, lift, and move up to four stacks of chairs 70. The chair lifting and moving assembly 10′ has a frame 12′, the frame 12′ has a plurality of wheels 14′ attached to a respective one of the wheel supports 16′. The wheel supports 16′ are more substantial in this assembly 10′. In fact, the wheel supports 16′ preferably have to generally parallel members 16a′,16b′ to support the extra chair members 18′,18″ and the weight of the stacks of chairs 70. The chair members 18′,18″ have a front portion 20′,20″ and a rear portion 22′,22″, respectively. The rear portion 22′ of the chair members 18′ are attached to a chair support member 24′, which extends across the back of the chair members 18′ and parallel to the frame 12′. The chair support member 24′ is also attached to tabs 26′, which are adjustably attached to the links 28′, which in turn are rotatably attached to the frame 12′. The links 28′ have a plurality of openings 30′ therein to allow for a variety of positions of the rear portion 22′ of the chair members 18′ relative to the back of the bottom chair in the stack of chairs to be lifted. The front portion 20′ also has tabs 32′ to rotatably attach to links 34′, which are fixedly attached to the wheel supports 16′.

The front chair members 18″ are spaced forward of the rear chair members 18′ and from one another to allow a second row of stacks of chairs 70 to be lifted and moved. The front portion 20″ and rear portion 22″ are attached to the wheel supports 16′ with tabs 32′ and links 34′.

A handle 40′ is attached to the rear portion 22′ of the chair lifting members 18′, although the handle 40′ could be attached to the chair support member 24′ or even the frame 12′.

A lifting member 50′, which is preferably a hydraulic pump, is secured to the frame 12′, and more particularly to the two cross members 52′, 54′. The lifting member 50′ is also connected to the U-shaped element 56′, which is connected to the links 28′. When the lifting member 50′ is activated, typically by the foot pedal 58′, it pushes upward on the U-shaped element 56′, which in turn pulls the links 28′ upward. The links 28′ in turn pull upward on the chair members 18′ thereby lifting the chair members 18′. The front portion 20′ of the rear chair member 18′ is attached to the rear portion 22″ of the front chair member 18″ so that the movement of the rear chair member 18′ causes the movement of the front chair member 18″. While the front portion 20′ of the rear chair member 18′ is attached to the rear portion 22″ of the front chair member 18″ in a center portion thereof, the attachment point of the two chair members 18′,18″ may be positioned to one side or the other.

Similarly, the front chair members 18″ may also be attached to a lifting member 50′ through the U-shaped element 56′. Alternatively, there could be two different lifting members 50′ that lift selected ones of the chair members 18′,18″. For example, the rear chair members 18′ could be lifted by one lifting member while the front chair members 18″ could be lifted by the other. Additionally, the left chair members 18′,18″ could be lifted according to sides-left side and right side.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. A chair lifting and moving assembly comprising:
a frame having a plurality of wheels;
at least two chair members, each of the at least two chair lifting members having a front portion and a rear portion;
a lifting member operatively coupled to the at least two chair members and the frame to lift at least the front portion of the two chair members; and
a handle attached to the at least two chair members.

2. The chair lifting and moving assembly according to claim 1, wherein the at least two chair members are adjustably attached to the frame.

3. The chair lifting and moving assembly according to claim 1, wherein the frame has two wheel supports, each of the wheel supports disposed along a longitudinal axis of a respective one of the at least two chair members.

4. The chair lifting and moving assembly according to claim 1, wherein the at least two chair members are attached to a chair member support, the chair member support being pivotally attached to the frame.

5. The chair lifting and moving assembly according to claim 1, wherein the two wheel supports are parallel to one another.

6. The chair lifting and moving assembly according to claim 1, wherein the lifting member is a hydraulic pump.

7. The chair lifting and moving assembly according to claim 4, wherein each of the front portions of the chair lifting members is pivotally attached to one of the wheel supports.

8. The chair lifting and moving assembly according to claim 3, wherein at least one wheel on the wheel supports is disposed under each of the at least two chair members.

9. The chair lifting and moving assembly according to claim 1, wherein the front portion is lifted higher than the rear portion upon actuation of the lifting member.

10. The chair lifting and moving assembly according to claim 1, wherein the at least two chair members comprises four chair members.

11. The chair lifting and moving assembly according to claim 4, wherein the four chair members being pivotally attached to the wheel supports.

12. The chair lifting and moving assembly according to claim 1, wherein each of the at least two chair members are adjustably mounted to the chair lifting and moving assembly.

13. A chair lifting and moving assembly comprising:
a frame having a plurality of wheels;
at least two chair members, each of the at least two chair lifting members having a front portion and a rear portion; and
a lifting member operatively coupled to the at least two chair members and the frame to lift at least the front portion of the two chair members.

14. The chair lifting and moving assembly according to claim 13, wherein the at least two chair members comprises four chair members.

15. The chair lifting and moving assembly according to claim 13, further comprising a second chair support member and the at least two chair members comprises four chair members, the second chair support member being attached to two of the four chair members.

16. The chair lifting and moving assembly according to claim 13, wherein each of the at least two chair members are adjustably mounted to the chair lifting and moving assembly.

17. A chair lifting and moving assembly comprising:
a frame, the frame having two wheel supports and the two wheel supports having a plurality of wheels;
at least two chair members, each of the at least two chair lifting members having a front portion and a rear portion; and
a lifting member operatively coupled to the at least two chair members and the frame to lift at least the front portion of the two chair members.
at least one wheel on the wheel supports is disposed under each of the at least two chair members,
wherein each of the wheel supports is disposed along a longitudinal axis of a respective one of the at least two chair members.
